(19) United States
(12) Patent Application Publication
(10) Pub. No.: US 2017/0232679 A1
(43) Pub. Date: Aug. 17, 2017

(54) Apparatus for Fabricating an Object

(71) Applicant: LAING O'ROURKE AUSTRALIA PTY LIMITED, North Sydney (AU)

(72) Inventors: James Bruce Gardiner, Chippendale (AU); Lex Matthew, Chippendale (AU)

(21) Appl. No.: 15/502,112

(22) PCT Filed: Aug. 5, 2015
(86) PCT No.: PCT/AU2015/050439

§ 371 Date: Feb. 6, 2017

(30) Foreign Application Priority Data
Aug. 5, 2014 (AU) 2014903027

(51) Int. Cl. B29C 67/00; B33Y 50/02; B33Y 30/00

(52) U.S. Cl. CPC B29C 67/0088; B29C 67/0055; B33Y 30/00; B33Y 50/02

(57) ABSTRACT

A computer-controlled additive manufacturing apparatus for fabricating an object. The apparatus includes a deposition head for selectively expelling first material therefrom, a reservoir containing a fluid-like second material, and a controller. At least one of the deposition head and at least a portion of the reservoir are movable, and the controller is configured to move at least one of the deposition head and the at least a portion of the reservoir relative to each other, and selectively operate the deposition head to expel the first material therefrom, responsive to computer instructions, thereby progressively depositing the first material in specific locations to fabricate the object having at least a portion thereof submerged in the second material.

### TECHNICAL FIELD

The present invention relates generally to fabricating objects and in particular, relates to fabricating an object with a computer-controlled ‘additive manufacturing’ apparatus.

### BACKGROUND TO THE INVENTION

Objects have been fabricated using a range of different casting or moulding techniques for some time. Casting or moulding generally involves introducing molten material, such as plastic or metal, into a cavity defined by a mould tool. After the material cools and hardens, a solid object is removed from the tool having a corresponding geometry to the cavity.

Whilst casting or moulding often proves reliable, these processes also suffer from a number of drawbacks. For example, as design and engineering has become more sophisticated, the need for non-standard ‘freeform’ geometry objects has increased. One issue common to many non-standard geometry objects is the presence of ‘undercut’ or ‘over-hanging’ surfaces. If an object is cast or moulded having such surfaces using a conventional, rigid mould tool, the tool becomes trapped by the undercut surfaces against the object when the molten material solidifies, proving difficult or impossible to remove the mould tool from the object without damaging the object and/or the tool.

Past solutions to overcome this issue have involved using a complex, multi-part tool which has a number of parts which can be disassembled to release the tool from the undercut surfaces. However, these tools are typically expensive due to the complexity of the moving tool parts and can require a considerable length of time and/or energy to remove the tool from the object.

One attempt to address this issue has been the adoption of ‘additive manufacturing’ techniques to fabricate a complex geometry object. Additive manufacturing generally involves selectively adding material, or bonding material together, to form successive planar layers, until the layers form the object. As additive manufacturing generally does not require a mould tool, this mitigates the issue of removing the tool from the fabricated object.

However, additive manufacturing techniques also suffer from other drawbacks. For example, one of the most popular additive manufacturing techniques involves the selective deposition of material to build the object—commonly known as ‘fused deposition modelling’ (FDM). When an object having an over-hanging portion is fabricated using an FDM approach, the over-hanging portion can be prone to deforming (known as ‘slumping’) due to gravity deforming deposited material before the material has cured. This is particularly the case where the material being deposited has low viscosity, is particularly dense or requires substantial time to cure.

To reduce the effects of gravity deforming an object fabricated by an FDM process, it is known to construct one or more scaffold structures (known as ‘supports’) adjacent the over-hanging portion to provide additional support. However, the fabrication and/or installation of support structures consumes materials and time, and typically requires a post-fabrication process to remove the support structures from the object, further increasing the complexity and cost of this approach. Furthermore, as slumping can occur within individual layers of a fabricated object, whereby a layer geometry deforms prior to curing, the addition of support structures does not typically address this issue.

Accordingly, it would be useful to provide an alternative method and/or apparatus for fabricating an object which reduces or eliminates the potential for the fabricated object to deform during the fabrication process.

### SUMMARY OF THE INVENTION

According to one aspect of the invention, there is provided a computer controlled apparatus for fabricating an object, the apparatus comprising: a deposition head in communication with a supply of first material and adapted to expel the first material therefrom; a reservoir containing a fluid-like second material; and a controller; wherein at least one of the deposition head and at least a portion of the reservoir are movable, and the controller is configured to move the deposition head and the at least a portion of the reservoir relative to each other, and selectively operate the deposition head to expel the first material therefrom, responsive to computer instructions relating to the object geometry, thereby progressively depositing the first material in specific locations to fabricate the object having at least a portion thereof submerged in the second material.

Other aspects are also disclosed.

### BRIEF DESCRIPTION OF THE DRAWINGS

Preferred embodiments of the invention will now be described, by way of example only, with reference to the accompanying drawings in which:

FIGS. 1A and 1B are a cross-section views of an apparatus fabricating two different objects;

FIG. 2A is a perspective view of an alternative apparatus fabricating an alternative object;

FIG. 2B is a plan view of the apparatus shown in FIG. 2A fabricating a further alternative object;

FIGS. 3A-3D are cross-section views of a further alternative apparatus fabricating a further alternative object;

FIG. 4 is a perspective view of a further alternative apparatus fabricating a further alternative object;

FIG. 5 is a cross-section view of a further alternative apparatus fabricating a further alternative object;

FIG. 6 is a cross-section view of the apparatus shown in FIG. 5 fabricating a further alternative object;

FIG. 7 is a cross-section view of a further alternative apparatus fabricating a further alternative object;

FIGS. 8A and 8B are cross-section views of the apparatus shown in FIG. 7 fabricating a further alternative object;

FIGS. 9A and 9B are cross-section view of a further alternative apparatus fabricating a further alternative object;

FIG. 10 is cross-section view of a further alternative apparatus fabricating a further alternative object;

FIG. 11 is a perspective view of a fixing plate;

FIGS. 12A to 12E are cross-section views of various stages of fabricating a further alternative object;

FIG. 13 is a cross-section view of a further alternative apparatus fabricating a further alternative object; and

FIG. 14 is a cross-section view of a further alternative apparatus fabricating a further alternative object.

### DETAILED DESCRIPTION OF PREFERRED EMBODIMENTS

The present disclosure relates generally to methods and apparatus for fabricating an object using a computer-controlled apparatus, responsive to computer instructions relating to the object geometry. In particular, the disclosure relates to a computer-controlled apparatus for fabricating an object which includes a deposition head in communication with a supply of first material and adapted to expel the first material therefrom, a reservoir which is at least partially filled with a fluid-like second material, and a controller configured to selectively move at least one of the deposition head and at least a portion of the reservoir relative to each other, and selectively operate the deposition head, in order to deposit the first material in specific locations to form an object which corresponds with the object geometry, whereby at least a portion of the object is submerged in the second material.

The disclosed apparatus and method is useful when fabricating an object which has potentially fragile geometry which could be prone to deforming during the fabrication process and therefore would benefit from being supported. For example, this may be due to the object having ‘over-hanging’ or ‘undercut’ surfaces or portions which could be prone to slumping due to gravity before the deposited material the object is fabricated from cures (hardens). As the disclosed apparatus fabricates the object at least partially within the fluid-like second material, the second material flows around the object and provides structural support thereto which prevents slumping. This is particularly useful when large-scale objects, such as furniture or architectural structures, are being fabricated, as the effect of gravity can be more damaging to the object geometry. When the object has been fabricated, it can be lifted out of the reservoir, or the second material drained from the reservoir, in either case avoiding removal of conventional support structures in a post-fabrication process. Furthermore, the second material can then be re-used in subsequent fabrication cycles, thereby providing a sustainable fabrication process which produces little waste.

The disclosed apparatus and method can also be advantageous when fabricating an object from a material which typically requires a substantial amount of time to cure, as the fluid-like second material may be configured to accelerate the curing of the material. For example, the second material may include accelerating agents and/or transmit energy therethrough to decrease the curing period. Similarly, the second material may include other compounds and/or transmit energy therethrough to affect other properties of the object. For example, the second material may be heated/cooled to one or more specific temperatures to reduce heat stress generated in the fabrication process which may deform the object or otherwise be detrimental to its structure. Alternatively, the second material may contain pigments/dyes, coating/sealing materials, or polymerising agents, thereby avoiding one or more post-fabrication processes. This also allows further processes to be executed without moving the object, which is useful where the object is potentially fragile.

‘Selective deposition’ of material is discussed throughout the present disclosure. This will be appreciated to include all known methods of selectively expelling material from the apparatus to fabricate a structure. For example, ‘deposition’ includes extruding, jetting, spraying and additive welding of material.

Similarly, ‘fluid-like’ materials are discussed throughout the present disclosure. This will be appreciated to include all known materials which are capable of exhibiting fluid-like properties when in a natural state or when excited by energy, such as when vibrated. For example, this includes liquids, molten materials, granular materials, pellets of material and micro-spheres of material i.e. very small balls or fragments of solid material.

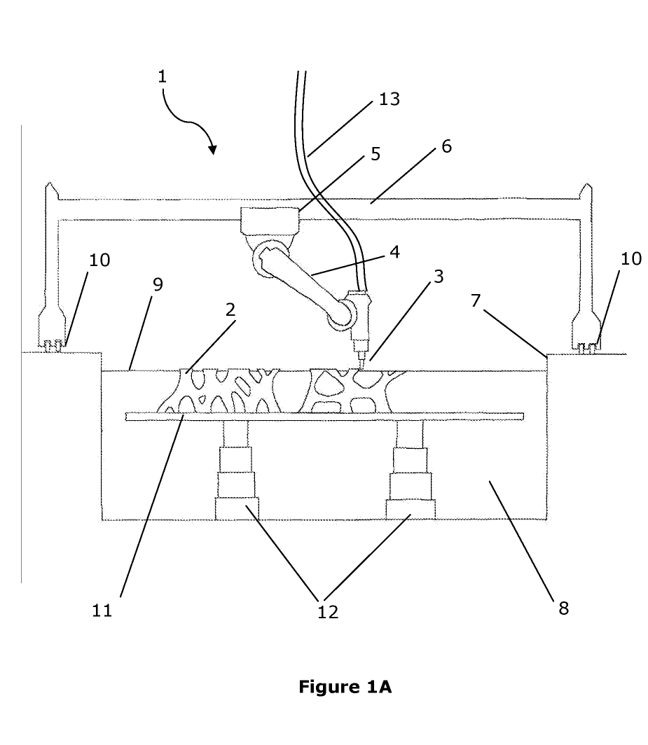

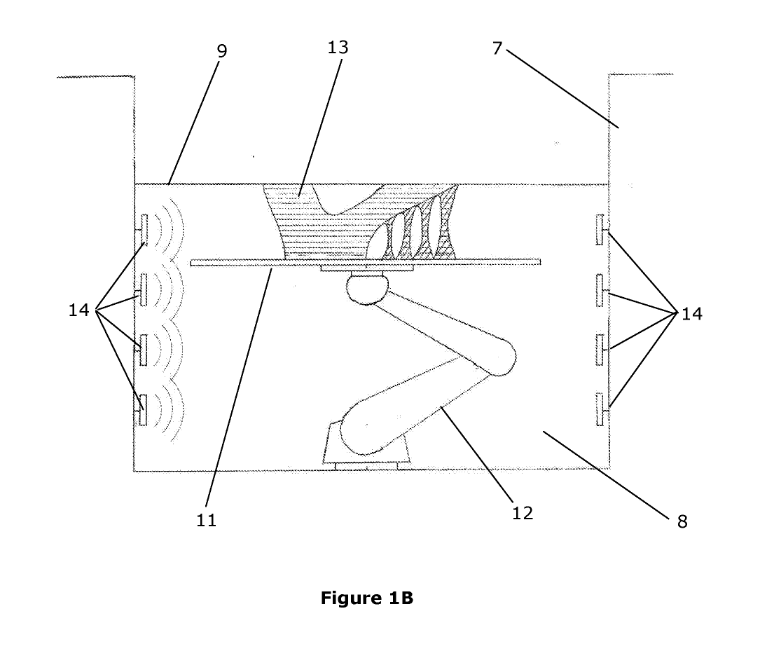

In FIG. 1A, an apparatus 1 is shown fabricating an object 2, the apparatus 1 having a deposition head 3 in communication with a supply of first material, being the ‘build material’ used to fabricate the object 2 therefrom, via a hose 13. The deposition head 3 is suspended above and movable in all three dimensions relative to a reservoir 7, including within the reservoir 7, by a robotic arm 4 slidable along a gantry 6, the gantry being slidable relative to the reservoir 7 along tracks 10. The reservoir 7 is at least partially filled with a fluid-like second material 8 which surrounds a submerged portion of the object 2. The object 2 is supported on a platform 11 disposed within the reservoir 7 and movable therein by one or more telescopic supports 12. The deposition head 3, platform 11 and/or the reservoir 7 are movable relative to each other by a controller (not shown), responsive to computer instructions provided to the apparatus 1. Whilst a gantry arrangement is shown, it will be appreciated that the robotic arm 4 may be secured to a surface adjacent the reservoir 7 and be movable relative to the reservoir 7 by other means, such as tracks or wheels. Similarly, a plurality of deposition heads 3 (not shown) may be provided on drones (not shown), being autonomous devices able to move relative to the reservoir 7 and potentially across or within the second material 8 contained therein. Alternatively, the deposition head 3 may be stationary and the reservoir 7 is movable (not shown) relative to the deposition head 3.

The controller is configured to move and selectively operate the deposition head 3 responsive to the computer instructions. The computer instructions are derived from a digital three-dimensional (3D) model of the object 2. The 3D model is typically created by computer aided design (CAD) software operated by one or more of a user and algorithm. The CAD software typically divides the 3D model geometry into a plurality of cross-sectional layers and/or paths and derives the computer instructions therefrom which direct the apparatus 1 to deposit material to form corresponding layers and/or paths, in order to fabricate the object 2.

The object 2 is typically fabricated by the controller moving at least one of the deposition head 3 and reservoir 7 relative to each other and selectively operating the deposition head 3 to expel the first material therefrom, responsive to the computer instructions, thereby selectively depositing the first material in specific locations. At least some of the deposited first material is submerged in the second material 8 in the reservoir 7, thereby providing mechanical support for the submerged deposited first material. First material is progressively deposited from the deposition head 3 to form beads and/or layers until the deposited first material corresponds with the object geometry, and therefore the object 2 is fabricated. At the same time, the object 2 is typically progressively submerged into the second material 8 thereby supporting the object 2 throughout the fabrication process. This may be by the platform 11 lowering the object 2 into the reservoir 7 (and into the second material 8) and/or by additional second material 8 being added around the object in the reservoir 7.

Often the object 2 is fabricated by the first material being deposited in successive layers, each layer corresponding with a cross-section of the object geometry. In this scenario, the platform 11 is elevated above the second material 8 prior to the deposition of any first material to allow at least a portion of a first layer to be deposited directly onto the platform 11. The platform is then lowered into the reservoir 7 by approximately the distance of a thickness of the first layer, and a second layer is fabricated at least partially in contact with the first layer to allow the layers to bond. This is repeated until the layers form the object 2, and the object is completely submerged in the second material 8. However, it will be appreciated that the object 2 may be fabricated from a single continuous layer, such as a continuously deposited bead of first material. This may involve the platform 11 being lowered continuously, in proportion to the deposition of the first material.

The first material is typically any settable material capable of being supplied to the deposition head 3 in a substantially liquid or fluid-like state. This may be by supplying liquid first material from a reservoir through the hose 13. Alternatively, this may be due to melting solid material, such as a feedstock or filament first material, in or proximal to the deposition head 3, to form molten first material. Alternatively, the first material is a granular material which is selectively sprayed or jetted from the deposition head 3, potentially assisted by the apparatus 1 causing the first material to vibrate prior to exiting the deposition head 3, therefore temporarily inducing a fluid-like state.

When the first material is configured as a granular material, the granular first material may adhere to other, previously deposited granular first material due to being magnetically or statically charged and therefore being attracted to the previously deposited first material. Alternatively, the deposition of the granular first material may be followed by the apparatus 1 causing the granular first material to bind with previously deposited first material, such as by spraying a binding agent on the material, such as a glue, or applying energy, such as heat, to the first material to at least partially melt the material and cause the first material to bond. Furthermore, a combination of these approaches may be utilised.

The deposition head 3 may be supplied with more than one first material to allow a composite material object 2 to be fabricated. For example, the deposition head 3 may comprise a plurality of nozzles each in communication with a different first material, or the head 3 may comprise a mixing assembly, adapted to selectively mix a plurality of first materials supplied thereto to formulate a compound material. The different first materials may include reinforcement fibres which are selectively added to a carrier material for strengthening specific portions of the object 2. Alternatively, the first material may comprise a catalyst and base material, whereby the catalyst initiates or accelerates curing of the base material, or otherwise affects the properties of the base material.

The second material 8 is generally any material having or able to exhibit fluid properties, such as being able to flow and form a level top surface. The second material 8 is typically configured according to the properties of the one or more first materials supplied to the deposition head 3. For example, the second material 8 formulation may be determined by the density of the first material. For example, the second material may be configured to have a lower density than the first material in order to compress the object 2 and/or cause the object 2 to sink. Alternatively, the second material 8 may be configured have a higher density than the first material in order to float the object 2 therein.

Where the first material has a low density, such as a wax compound, the second material 8 may be water. As the wax compound is relatively buoyant in water, this would therefore provide support for the object 2.

Alternatively, where the first material has a high density, such as concrete or cement, the second material 8 may be a bentonite water slurry, thereby also providing support for the object 2.

The second material 8 may include compounds configured to affect properties of the first material. For example, the compounds may accelerate, retard or modify the curing of the first material, and such compounds be selectively added to the reservoir 7 by the apparatus 1 at specific intervals during the fabrication of the object 2, to affect the curing of the first material. For example, an additive may be included in the second material 8 which initiates or accelerates the curing of the first material, or which permeates into the first material to affect curing to a specified depth, such as accelerating the formation of a shell around the object 2. Such an additive may be configured to only temporarily affect the first material, such as temporarily hardening or strengthening the first material. Alternatively, an additive may be added into the reservoir 7 by the apparatus 1 to form a barrier layer (not shown) over the second material 8 to affect the curing of the first material or preclude substances entering the reservoir 7 and penetrating the first material and/or the second material 8. For example, a barrier gas layer may be formed across the second material 8 to prevent oxygen penetrating the first material and causing oxidization.

Where the second material 8 contains additives, the apparatus 1 may further comprise mixing means (not shown) for mixing the second material 8 to ensure the composition of the second material 8 is homogenous, particularly where components of the second material 8, such as catalyst additives, are consumed during the fabrication process.

The second material 8 may include other additives to affect other properties of the first material. For example, the second material 8 may include pigments or dyes to colour the object 2, with certain pigments arranged in certain portions of the reservoir 7 to affect corresponding portions of the object 2. Alternatively, the second material 8 may include a compound which adheres to the first material to form a coating around the object 2, such as granite powder. Similarly, the second material 8 may include abrasive or acidotic compounds which erode and smooth outer surfaces of the object 2.

The reservoir 7 may further include climate control means (not shown) to adjust environmental conditions of the reservoir 7, such as the temperature or humidity of the volume defined by the reservoir 7, thereby allowing the properties of the second material 8 and the object 2 submerged therein to also be adjusted. For example, where the first material is a wax compound, the climate control means may cool the second material 8 to accelerate hardening of the wax compound after deposition, which can decrease deformities forming in the object 2 from heat accumulated within the wax compound. Alternatively, the reservoir 7 may be heated to control the rate of cooling of the object 2, to avoid issues such as shrinkage, delamination of layers, or cracking of external surfaces.

FIG. 1B shows the apparatus 1 fabricating an alternative object 13 substantially submerged in the second material 8, the object comprising a body 131 and a support structure 132 extending between an over-hanging portion of the body 131 and the platform 11, to provide support for the over-hanging portion. Where the geometry of the object 13 requires an additional support structure 132 to be present, such as the over-hanging portion, the second material 8 is useful as this reduces the quantity of material required to construct the support structure 132.

The reservoir 7 has a plurality of vibration panels 14 arranged therein which are selectively operable by the controller to agitate at least a portion of the second material 8. The panels 14 are typically operated prior to or simultaneously with moving the platform 11 to induce shear thinning of the second material 8, or otherwise affect the state of the second material 8, to decrease its resistance to the motion of the platform 11 and object 13. This is useful where the second material 8 is highly viscous or is a granular material. Whilst the panels 14 are shown as movable planar elements, it will be appreciated that a range of other vibration generating or fluid mixing mechanisms are within the scope of this disclosure.

Alternatively, the second material 8 may have low viscosity and be configured to shear thicken when energy is applied to the second material 8, such as bigham plastic, thereby temporarily increasing the viscosity of the second material 8. When the second material 8 is configured as a shear thickening material, the apparatus 1 may be adapted to continuously agitate the second material 8 to shear thicken the material to provide the necessary support when the object 13 is being fabricated, and cease agitating the second material 8 when the object 13 and/or platform 14 is moved through the second material 8.

In an alternative embodiment of the apparatus (not shown), the apparatus is connected to a supply of the second material 8 and is adapted to selectively add the second material 8 to the reservoir 7, responsive to the computer instructions. For example, the apparatus may have a fluid outlet port arranged within or proximal to the reservoir 7 which has a selectively operable valve thereacross. By operating the valve, additional second material 8 is allowed to flow from the outlet and into the reservoir 7, thereby increasing the volume of second material contained in the reservoir 7.

In this alternative embodiment of the apparatus, the object 2 is fabricated by the deposition head 3 as previously described, such that at least a portion of the object 2 abuts or adheres to the reservoir 7, or a support structure arranged within the reservoir 7. Concurrently, the apparatus selectively operates the valve, allowing additional second material 8 to flow into the reservoir 7 to at least partially submerge the object 2. The second material 8 is typically added to the reservoir 7 in proportion to the progressive fabrication of the object 2, thereby increasing the volume of the second material 8 in the reservoir 7 to further support the object 2 as it is fabricated. The second material 8 may be added at regular stages, or may be added continuously, as the object 2 is fabricated. Alternatively, additional second material 8 may only be added to the reservoir 7 if a defined threshold is exceeded, for example, when a portion of the object 2 is determined by the apparatus as having geometry which exceeds defined properties, and therefore requires support from the second material 8. In this case, the second material 8 is allowed to flow into the reservoir 7 when the geometry threshold is exceeded. In order to assist the level of the second material 8 rising uniformly as additional second material 8 is introduced into the reservoir 7, particularly where the second material 8 is viscous, the apparatus may include one or more vibration generators or other mixing apparatus as described above.

When the apparatus is connected to a supply of second material 8, the second material 8 is typically stored remotely from the reservoir 7, such as in a reservoir (not shown) or hopper (not shown). The supply of second material 8 may be supplied due to the effect of gravity, or may be forcibly introduced into the reservoir 7, such as by a pump or conveying means. Similarly, the apparatus 1 may include a mechanism to selectively remove the second material 8 from the reservoir 7, such as a drain and/or pump, thereby allowing the second material 8 to be removed and potentially filtered and recirculated to the valve.

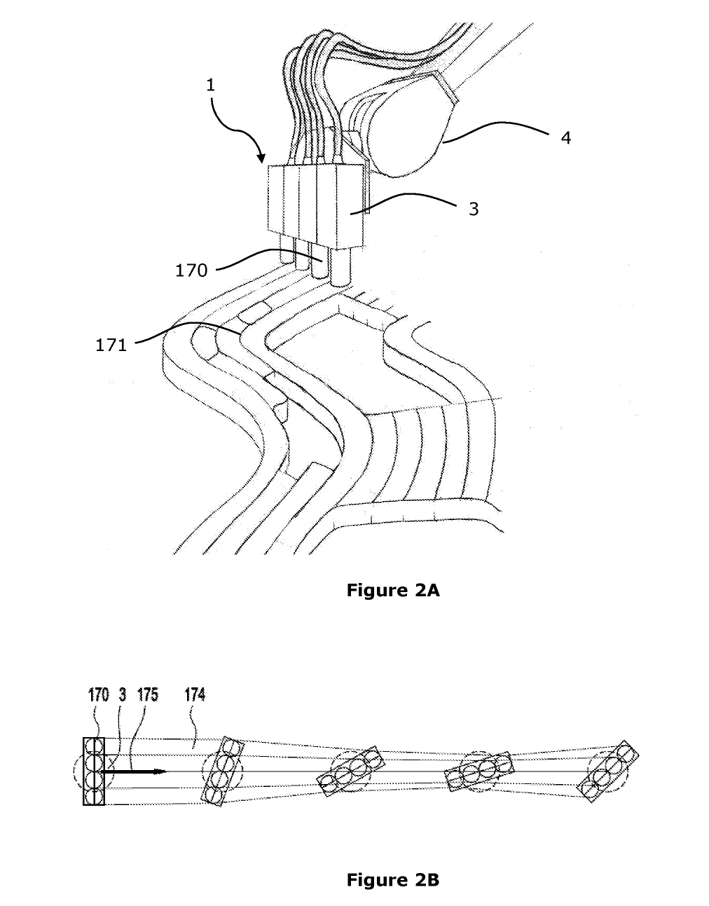

FIG. 2A shows an alternative aspect of the apparatus 1 in which the deposition head 3 has a plurality of nozzles 170 in communication with the first material, or with a respective plurality of different first materials. The nozzles 170 are arranged in a linear array and rotatably connected to the robotic arm 4. In use, the nozzles 170 are typically arranged substantially perpendicular to a top surface of a previously fabricated portion of the first material. As the deposition head 3 moves, the array of nozzles 170 are rotatable relative to the direction the deposition head 3 is travelling. The nozzles 170 may also be displaceable relative to each other, laterally across the deposition head 3, thereby allowing first material deposited therebelow to be deposited in separate streams.

In FIG. 2B an example of the deposition head 3 travelling along a path is illustrated, in which the deposition head 3 is moving in a first direction 175 and operating each nozzle 170 simultaneously, thereby depositing a corresponding portion 174 of first material. Whilst moving along the path, the array is rotated relative to the first direction, thereby decreasing the width of the solidified portion 174 and allowing the portion 174 to be continuously varied in width during fabrication.

The array of nozzles 170 selectively vary the flow rate of first material being deposited by each nozzle 170 during the fabrication of the path 174 in order to maintain deposition of a constant thickness layer. For example, as the array of nozzles 170 rotates to fabricate a thinner portion, the flow rate is proportionally decreased. Similarly, as the array of nozzles 170 travels around a curved path, the nozzle 170 arranged at the outside of the curve deposits at a greater rate than the nozzle arranged at the inside of the curve.

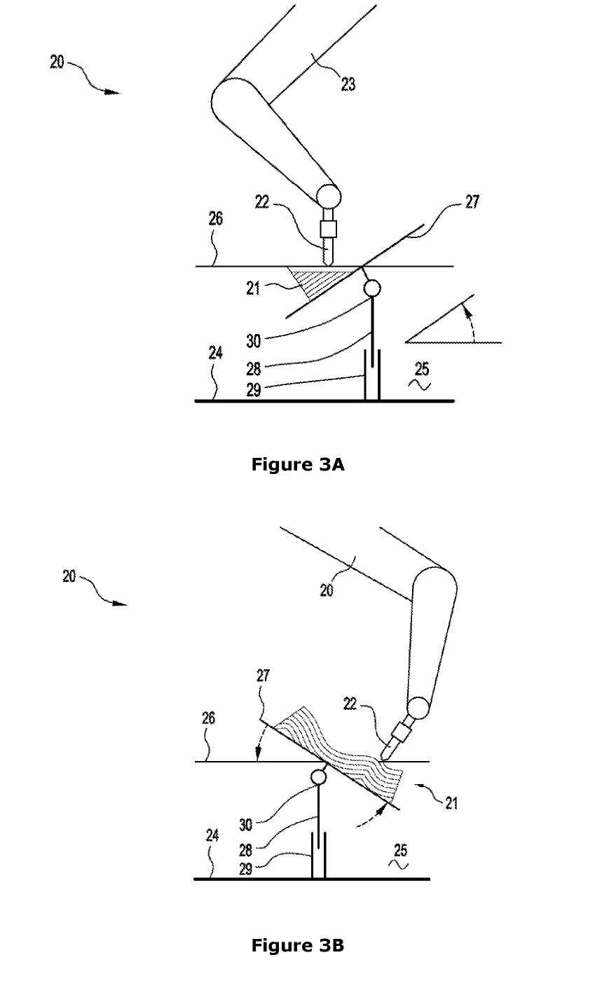

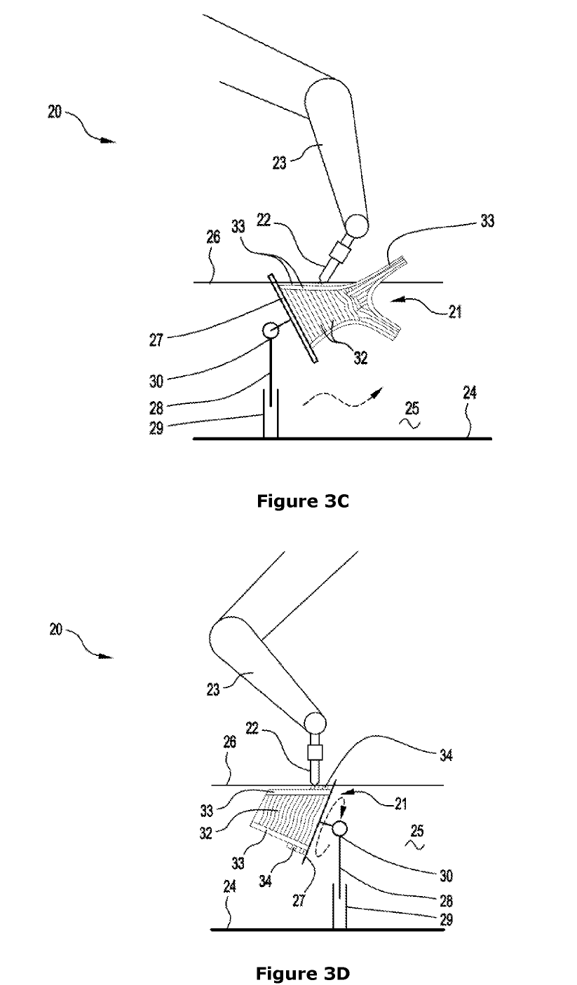

FIGS. 3A-3D show an alternative apparatus 20 fabricating an alternative object 21. The apparatus 20 has a deposition head 22 in communication with the first material and adapted to deposit the first material therefrom. The head 22 is rotatably connected to a first robotic arm 23 arranged above a reservoir 24 at least partially filled with the second material 25. Within the reservoir 24 is a platform 27 supported by a second robotic arm 28. The deposition head 22 and platform 27 are movable relative to each other by a controller (not shown), responsive to computer instructions relating to the object geometry provided to the apparatus 20.

The first robotic arm 23 and second robotic arm 28 each comprise a plurality of sections rotatably connected to each other to allow precise and flexible movement of the deposition head 22 and platform 27. The second robotic arm 28 adjusts the orientation and position of the platform 27 relative to the deposition head 22 by moving the platform 27 linearly, and/or rotatably, around at least one axis, and preferably three axes. As shown in FIGS. 3A-3D the second robotic arm 28 has one or more telescopic sections 29 and rotatable joints 30 adapted to provide linear and rotational movement of the platform 27. The repositioning and/or reorientation of the object 21 by the platform 27 may be performed simultaneously with the deposition head 22 being operated (and also moved), or may be performed in intermittent, successive stages, thereby allowing periods for deposited material to cure between stages of operating the deposition head 22.

The configuration of the apparatus 20 as shown in FIGS. 3A-3D is particularly useful where it would be advantageous to fabricate non-planar layers of the object 21, to provide specific functional or aesthetic properties. For example, as shown in FIG. 3B, the deposition head 22 and platform 27 may be moved, and the deposition head 22 operated, simultaneously to fabricate curved layers 31.

Referring to FIGS. 3C and 3D, the apparatus 20 also allows the cross-lamination of adjacent layers of the object 21, whereby first layers 32 are fabricated in a first orientation and second layers 33 are fabricated in a second orientation arranged in a different plane and/or angle to the first orientation, thereby forming a strong, lattice-like layer structure. This is most clearly shown in FIG. 3D, where a first set of layers 34 are fabricated substantially parallel to the platform 27. The second set of layers 35 are fabricated as columns, extending from the platform 27 and surrounding the first set of layers 34. A third set of layers 36 are fabricated as annular rings around the second layers 35, as the platform 27 is rotated during fabrication, thereby wrapping the third layers 36 around the second layers 35.

This arrangement of layers is particularly useful where, during use, the object 21 is likely to be subject to loading cycles which could delaminate a conventional stack of parallel planar layers, as the cross-lamination between layers can increase the strength of the bond between layers and provide improved resistance to delamination during the loading cycles.

In an alternative embodiment of the apparatus 20 (not shown), the reservoir 24 may also be selectively rotatable relative to the deposition head 22, or further alternatively, the platform 27 and the reservoir 24 may be selectively rotatable, during fabrication of the object 21 as described above. Where the reservoir 24 is selectively rotatable, the reservoir 24 has one or more gutters extending around a periphery thereof to collect second material 8 displaced due to rotation of the reservoir 24 and means to recirculate collected second material into the reservoir 24.

In a further alternative embodiment of the apparatus 20 (not shown), the reservoir 24 is configured as a substantially cylindrical drum and the reservoir 24 and platform 27 are selectively rotatable simultaneously, thereby centrifugally spinning the second material 25 in the reservoir 24 to the side-walls of the reservoir 24 and forming a well through the second material 25. This allows the first robotic arm 23 to move within the well and selectively deposit the first material onto the side-walls of the reservoir 24, whilst the second material 25 supports the deposited first material. In such instances, the second material 25 has a specific density relative to the first material, to assist deposited first material maintaining the desired geometry of the object. This arrangement of the apparatus is potentially useful when fabricating cylindrical or toroid objects, such as pipes having geometric features, for example, longitudinal ribs or surface patterns.

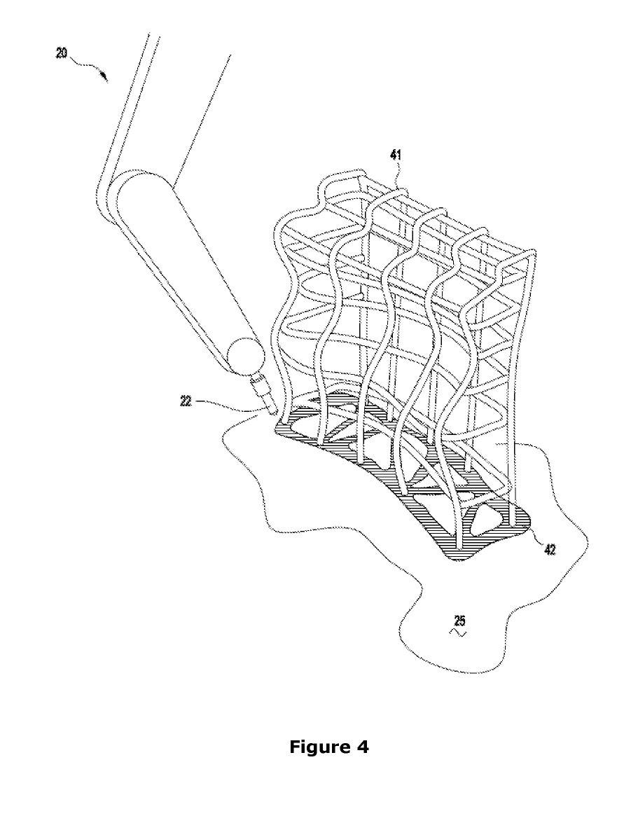

FIG. 4 shows an alternative aspect of the apparatus 20 shown in the previous figures. A reinforcement frame 41 is positioned on the platform 27 prior to the first material being deposited from the deposition head 22. The apparatus 20 progressively fabricates a shell 42 of the first material at least partially enclosing the frame 41, and the shell 42 and frame 41 are progressively submerged into the second material 25 by the platform 27 as further first material is deposited. Alternatively, the apparatus 20 positions individual components of the reinforcement frame 41 in specific locations with a gripper (not shown) whilst fabricating of the shell 42 to secure the components therein, and optionally also selectively joins the components to each other to form a reinforcement frame sub-assembly, such as by welding, bonding, or fixing with fasteners.

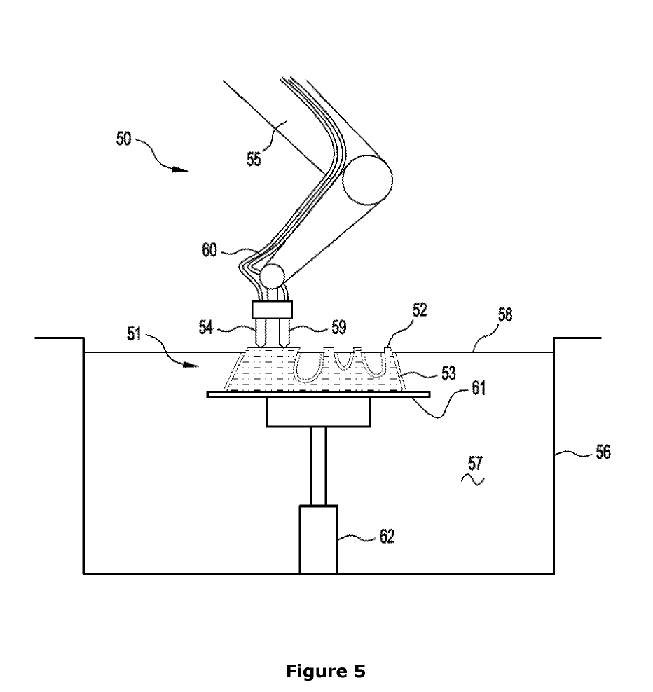

In FIG. 5 a further alternative apparatus 50 is shown fabricating a composite object 51, having a first object 52 integrated with a second object 53. The apparatus 50 has a first deposition head 54 and a second deposition head 59, both connected to a robotic arm 55 arranged above a reservoir 56 at least partially filled with fluid-like second material 57. Each of the deposition heads 54, 59 are in communication with one or more first building materials via hoses 60. Within the reservoir 56 is a platform 61 supported by a second robotic arm 62. The deposition heads 54, 59 and platform 61 are movable relative to each other by a controller (not shown), responsive to computer instructions relating to the first object geometry or the second object geometry. The deposition heads 54, 59 are selectively operable to expel the first material therefrom simultaneously or successively.

The apparatus 50 is particularly useful where the composite object 51 is specified to have different portions having different properties. For example, a light-weight, large-scale, structural composite object 51 may be required, and therefore the first object 52 may be a lightweight core formed from a foam material, and the second object may be a structural shell 53 formed from a cementitious material.

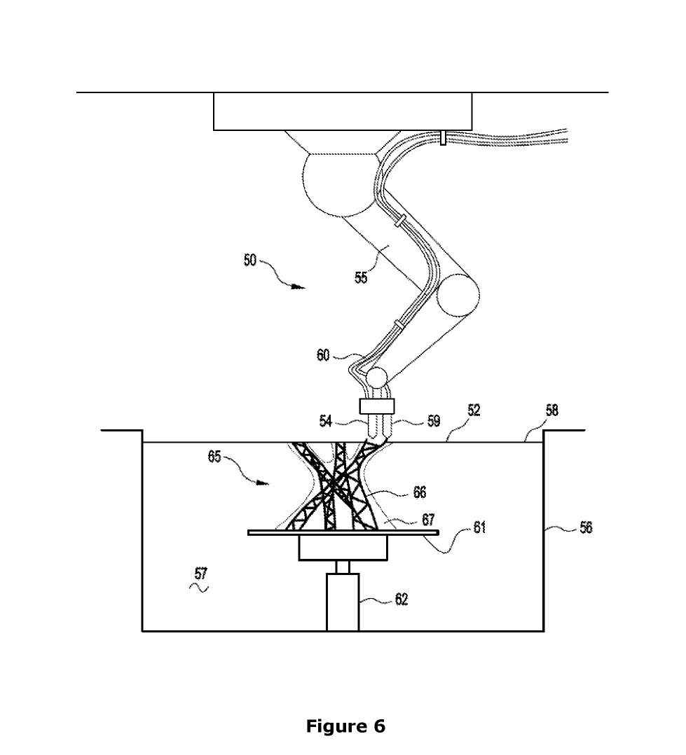

FIG. 6 shows the apparatus 50 fabricating an alternative composite object 65 formed from an alternative first object 66 and an alternative second object 67, as previously described. The first object 66 is configured as a reinforcement structure to increase the rigidity/strength of the composite element 65. For example, the first object 66 is formed from a suitably strong material, such as a metal or a paste having a high metal content, or a composite paste including fibres, such as carbon fibre. Alternatively, the first object 66 may be formed from an electrically conducting material, to transmit electricity therethrough, and/or may include a plurality of sensors therein, to enable remote monitoring of the structure, such as monitoring current loads or structural failure.

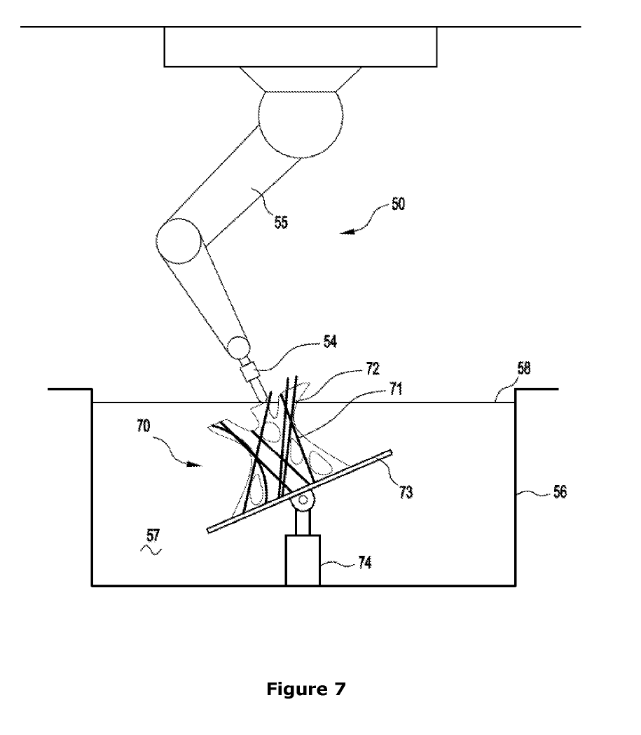

In FIG. 7, the apparatus 50 is shown fabricating a further alternative composite object 70 which includes a reinforcement structure 71 within a body 72. The apparatus has an alternative platform 73 rotatably connected around at least one axis, and preferably around 3 axes, to a support 74 within the reservoir 56, allowing the apparatus 50 to fabricate the reinforcement structure 71 and body 72 from non-planar layers and/or cross-laminated layers, as described above.

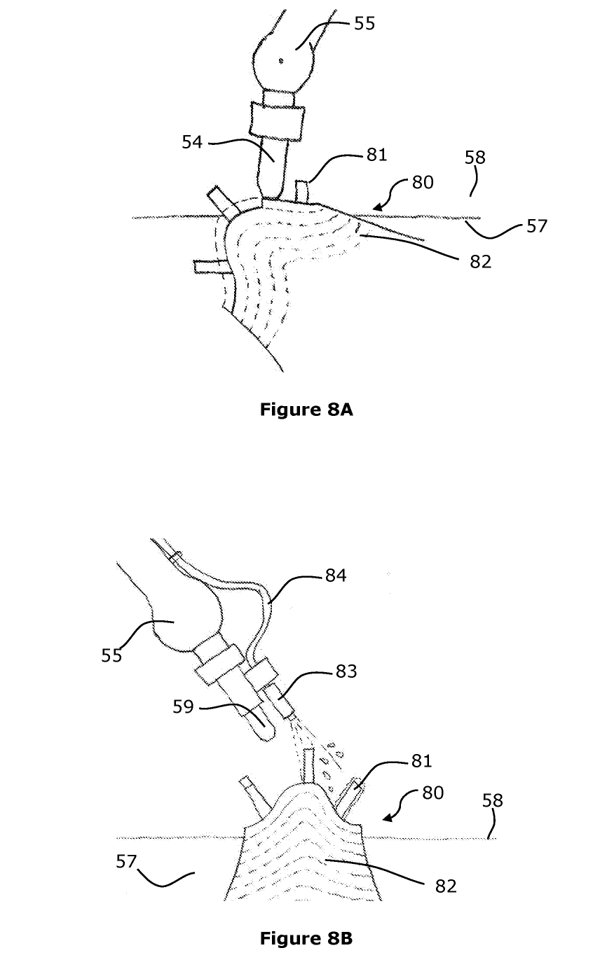

FIGS. 8A and 8B show an alternative aspect of the apparatus 50, being a nozzle 83 in communication with a gas via a hose 84 for selectively removing the second material 57 from an alternative object 80. The object 80 comprises a frame 81 and a body 82. In FIG. 8A, the platform 73 has tilted the object 80 to allow the deposition head 54 to deposit the first material on the body 82. As a result, some of the frame 81 is submerged in the second material 57. In FIG. 8B, the platform has tilted the composite element 80 upright such that the frame 81 is protrudes out of the second material 57. The nozzle 83 is then operated to at least partially remove the second material 57 from the frame 81 prior to further first material being deposited by the deposition head 59 to fabricate further portions of the frame 81 and/or body 82.

Optionally, the gas may comprise a curing agent, specified to initiate or accelerate the curing of the frame 81 and/or body 82, or include adhesives, or an exfoliating material to assist with interlayer bonding, such as a chemical that modifies a material such as wax to be hydrophilic rather than hydrophobic, or that breaks down oxides layers to assist material bonding. Also, a second gas may be applied, containing a coating, to coat the frame 81 and/or body 82, to affect the properties of each, such as an electrically conducting coating.

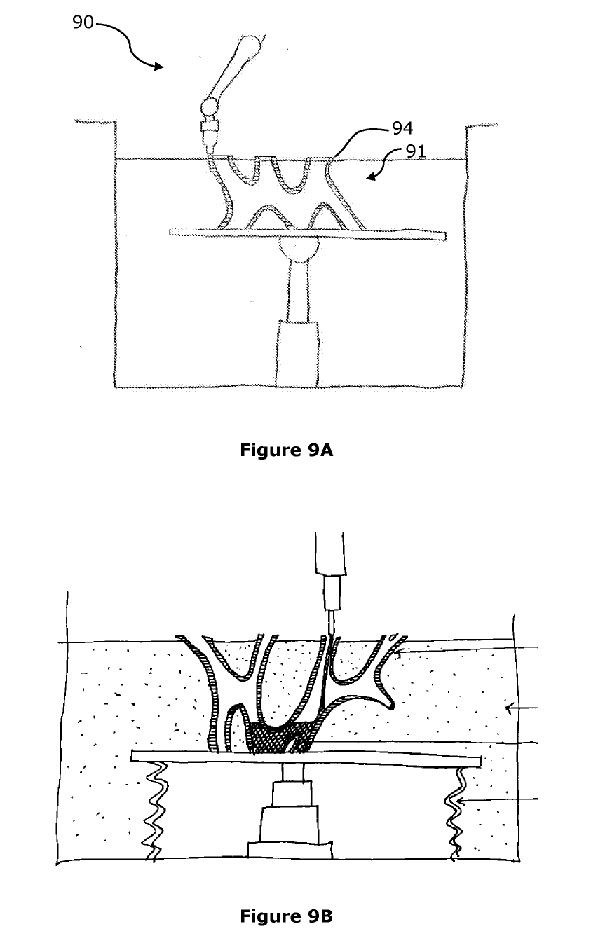

FIGS. 9A and 9B are cross-section views of a further alternative apparatus 90 fabricating a further alternative object 91. The apparatus 90 shares many of the features of the apparatus 20 described above, whereby common reference numerals refer to the same feature. The apparatus 90 further includes a nozzle 92 in communication with a supply of a curable third material 93, such as a cementitious material. Optionally, a skirt 96 is affixed between the platform 27 and the reservoir 24 to define a sealed void 97 therein, thereby preventing the second material 25 flowing under the platform 27.

In FIG. 9A a substantially hollow shell 94 is being fabricated by the apparatus 90 from the first material deposited from the deposition head 22. In FIG. 9B, the apparatus 90 is filling the shell 94 with the curable third material 93. After the shell 94 is filled with the curable third material 93, the curable material 93 is cured to form a solid, homogenous structure housed within the shell 94. The shell 94 may then be removed, for example, the shell 94 may be melted or dissolved from the cured third material 93. Alternatively, the shell 94 may be filled with the second material 25, or another material, in proportion to the shell 94 being fabricated by the deposition head 22, thereby providing support to the inside and outside of the shell 94 simultaneously during the fabrication process. The material filling the shell 94 may then be removed from the shell 94 before the curable material 93 is inserted therein.

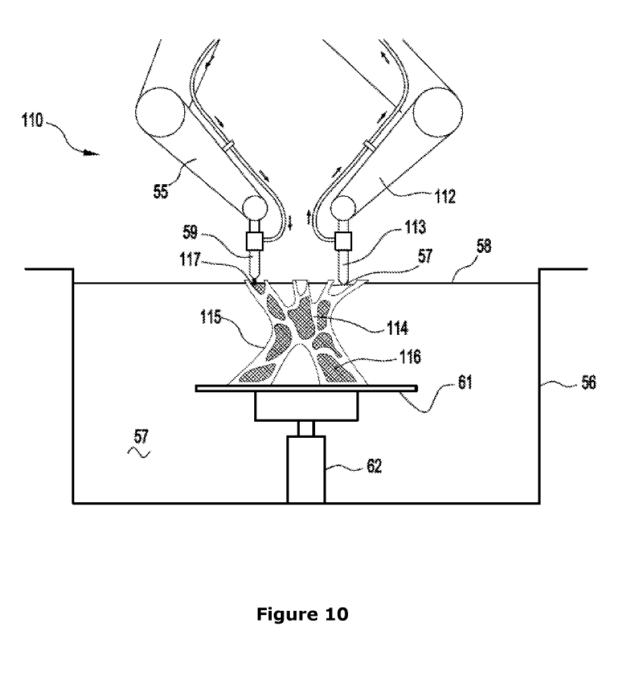

FIG. 10 shows a further alternative apparatus 110 sharing many of the features of the apparatus 50, whereby common reference numerals indicate common features. The apparatus 110 has a plurality of robotic arms 55, 112 movable relative to the reservoir 56, which is at least partially filled with the second material 57. The second arm 112 includes a nozzle 113 connected to a vacuum system (not shown) for selectively removing the second material 57 from the reservoir 56, responsive to computer instructions.

The apparatus 110 is shown partway through fabricating a further alternative object 114 having a body 115 fabricated by the first deposition head 54 from the first material, as described above. The body 115 defines a plurality of voids 116. During fabrication of the body 115, the second robotic arm 112 selectively removes second material 57 that becomes trapped in the voids 116. The second deposition head 59 may then deposit third building material 117 into the voids 116.

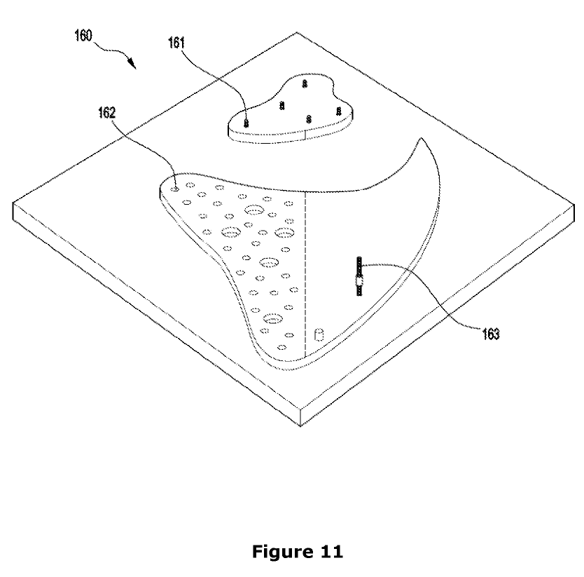

FIG. 11 shows a fixing plate 160 used in conjunction with any of the apparatus described above. The fixing plate 160 provides one or more fixtures 161 and/or textured regions, such as a perforated region 162, which a fabricated object (not shown) can adhere to, thereby affixing the object to the fixing plate 160. The fixing plate 160 is typically adapted to be releasably secured to the platform 27, 73 and permanently affixed to a fabricated object. Additional attachments, such as a threaded bar 163 are securable to the fixtures 161 during the fabrication process, thereby extending the length of a fixture within the fabricated object.

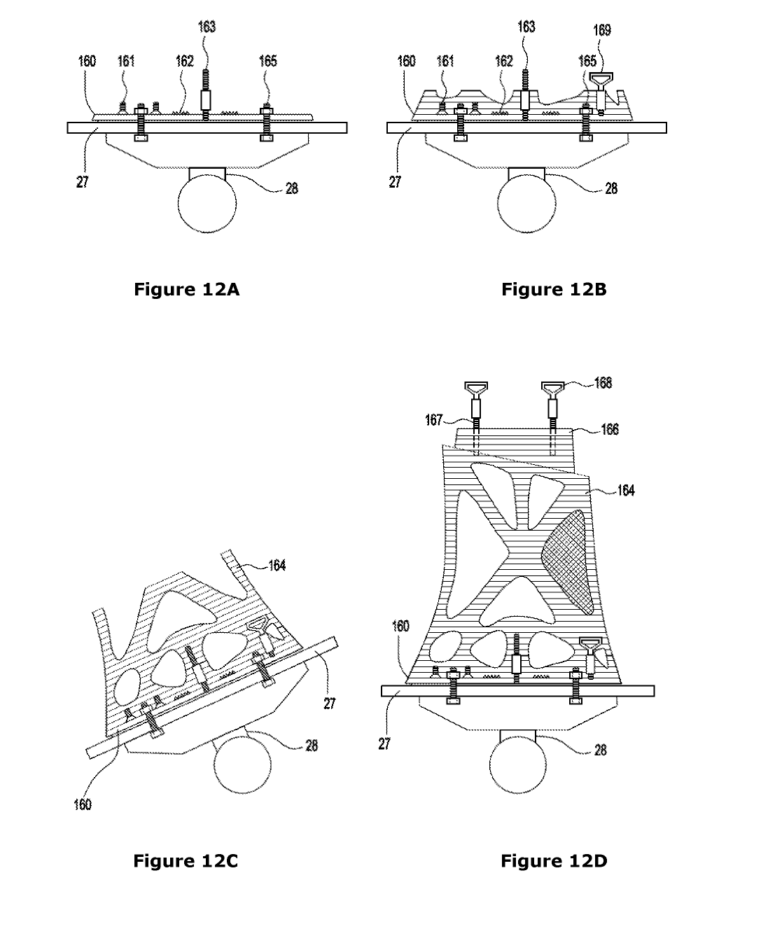

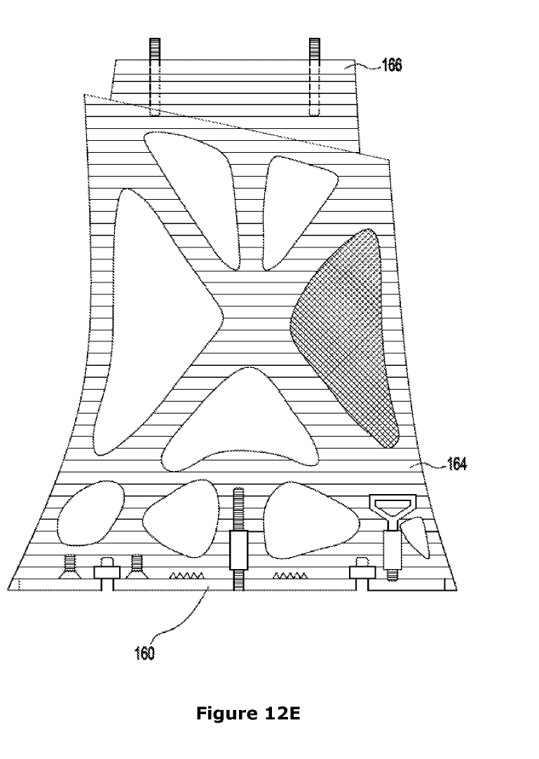

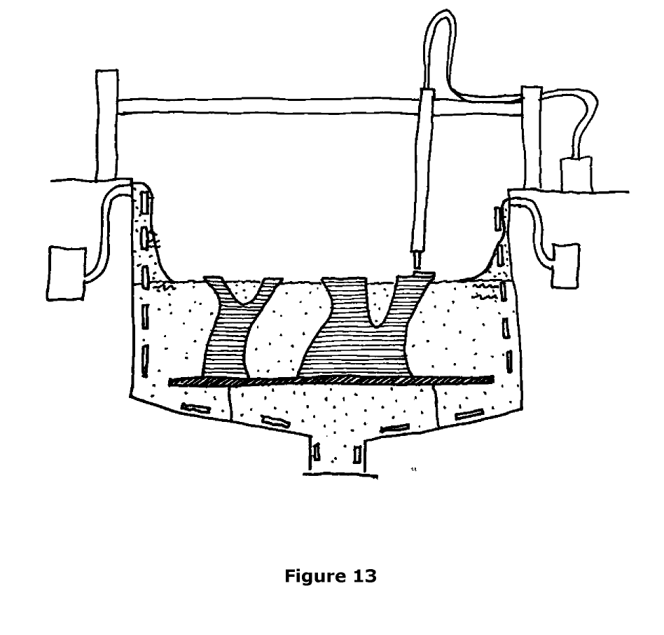

FIGS. 12A-12E show the fixing plate 160 attached to the platform 27, 73 during various stages of the apparatus 20, 50 fabricating a further alternative object 164. FIG. 12A shows the fixing plate 160 connected to the platform 27, 73 by fasteners 165. FIG. 12B shows layers of the object 164 fabricated on the fixing plate 160, threaded fixtures 161 and perforated region 162. An extender rod 163 and a load spreading fixture (169) are also connected to some of the threaded fixtures 161. FIG. 12C illustrates a later stage of the fabrication process, where the platform 27, 73 is rotated, thereby tilting the object 164 engaged with the fixing plate 160. FIG. 12D shows the complete object 164 having an additional fixing plate 166 connected to a top surface of the object 164 by two additional threaded fixtures 167. Respective removable lifting fixtures 168 are connected to the threaded fixtures 167. FIG. 12E shows the object 164 removed from the apparatus 20, 50, with both fixing plates 160, 166 engaged with the object 164.

FIG. 13 is a cross-section view of a further alternative apparatus 180 fabricating a further alternative object 181. The apparatus 180 includes a deposition head 182 in communication with a supply of a first material via a hose 183 and arranged proximal and movable relative to a reservoir 184 partly filled with a fluid-like second material 185. The object 181 is fabricated by the apparatus 180 selectively depositing the first material from the deposition head 182, as described above.

The second material 185 defines a top surface 186. The level of the top surface 186 in the reservoir 184, or more specifically, the position of the top surface 186 relative to a top surface 187 of the object 181, is adjustable by selectively operating a pump mechanism 188, thereby pumping additional second material 185 into the reservoir 186. The pump mechanism 188 has one or more outlets arranged around a periphery of the reservoir 184 to allow the second material 185 to flow into the reservoir 184. The pump mechanism 188 is typically operated concurrently with the deposition head 182, thereby raising the level of the second material 185 in proportion to further first material being deposited by the deposition head 182 to fabricate the object 181.

The reservoir 184 includes one or more oscillation units 189 arranged proximal to side-walls and a base of the reservoir 184, each oscillation unit 189 adapted to agitate the second material 185. This may be to induce levelling of only the top surface 186 as additional second material 185 is added into the reservoir 184, or to liquefy the entire volume of second material 185 in the reservoir 184 to enable movement of a platform 190 and object 181 therethrough. The oscillation units 189 are typically affixed relative to the reservoir 184. Alternatively, the oscillation units 189 are wirelessly operable and arranged within the second material 185, or further alternatively, adapted to be selectively inserted into the second material 185 at specific locations, for example, by a robotic arm (not shown), thereby allowing specific portions of the second material 184, and potentially also the object 181, to be vibrated.

A plurality of the oscillation units 189 may be arranged in one or more linear arrays extending between a rim 191 of the reservoir 184 and the base and be selectively operable to agitate specific portions of the second material 185. For example, only the oscillation units 189 arranged adjacent the top surface 186 may be operated to level the top surface 186 as further second material 185 is added to the reservoir 184. Alternatively, the intensity of vibration provided by the oscillation units 189 may be varied across the array, to liquefy different regions of the second material 185 by different amounts.

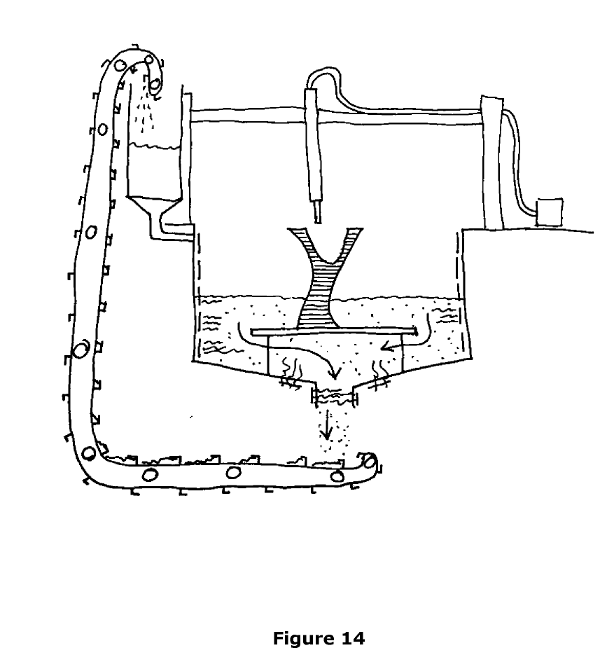

FIG. 14 shows a further alternative apparatus 200 fabricating a further alternative object 201. The apparatus 200 shares many of the features of the apparatus 180, whereby common reference numerals indicate common features. The apparatus 200 further includes a drain 202 at the base of the reservoir 184 having a selectively operable outlet valve arranged thereacross and in communication with a recirculation system 203, whereby operation of the outlet valve allows the second material 185 to flow through the drain 202 to the recirculation system 203. The recirculation system 203 is adapted to receive second material 185 from the drain 202 and transport the material 185 for selective redeployment into the reservoir 184. Typically, the recirculation system 203 includes conveying means 204 adapted to capture the second material 185 flowing through the drain 202 and pass the material 185 into a hopper 205. The hopper 205 has an orifice having an inlet valve arranged thereacross which is selectively operable to release the second material 185 from the hopper 205 and allow the material 185 to flow into the reservoir 184. The recirculation system 203 may also include a filtration system (not shown) for filtering the second material 185.

The recirculation system 203 is typically operated after the object 201 has been fabricated, in order to drain the second material 185 from the reservoir 184 and expose the object 201. The drained second material 185 is stored in the hopper 205 and selectively released into the reservoir 184 during fabrication of a subsequent object. Optionally, the recirculation system 203 may be operated, potentially continuously, whilst fabricating the object 201, in order to refresh the second material 185 contained in the reservoir 184, particularly if the second material 185 is filtered or otherwise treated whilst passing through the recirculation system 203. For example, if the second material 185 is configured to cause a reaction with the first material forming the object 181, such as accelerating curing of the first material, or forming a surface treatment on the object 201, this may generate a waste product, and therefore it may be necessary to continuously recirculate and treat the second material 185 to remove the waste product therefrom.

It will be apparent that obvious variations or modifications may be made to the present invention in accordance with the spirit of the invention and which are intended to be part of the invention. Although the invention is described above with reference to specific embodiments, it will be appreciated that it is not limited to those embodiments and may be embodied in other forms.

1. A computer-controlled apparatus for fabricating an object, the apparatus comprising:
a deposition head in communication with a supply of first material and adapted to expel the first material therefrom;
a reservoir containing a fluid-like second material for supporting the object; and
a controller;
wherein at least one of the deposition head and at least a portion of the reservoir are movable, and
wherein the controller is configured to move at least one of the deposition head and the at least a portion of the reservoir relative to each other, and operate the deposition head, to expel the first material to form one or more beads, responsive to computer instructions relating to the object geometry, thereby depositing the one or more beads of the first material in specific locations corresponding with the object geometry to progressively fabricate the object from only the first material, and submerging at least a portion of the object in the second material thereby supporting the at least a portion of the object.

2. The computer-controlled apparatus according to claim 1, wherein the reservoir further comprises a platform for supporting the object thereon, the platform being movable relative to the deposition head, and wherein the controller is configured to move the platform responsive to the computer instructions.

3. The computer-controlled apparatus according to claim 2, wherein the controller progressively lowers the platform into the reservoir in proportion to the deposition head progressively depositing the first material, thereby further submerging the at least a portion of the object in the second material.

4. The computer-controlled apparatus according to claim 2, wherein the platform is rotatable around at least one axis, and wherein the controller is configured to rotate the platform responsive to the computer instructions.

5. (canceled)

6. The computer-controlled apparatus according to claim 2, wherein the controller is configured to move the deposition head and the platform simultaneously responsive to the computer instructions.

7. (canceled)

8. The computer-controlled apparatus according to claim 2, wherein the platform has a skirt affixed between a peripheral region thereof and the reservoir to define a sealed void, whereby the skirt prevents the second material entering the void.

9. The computer-controlled apparatus according to claim 1, further comprising a connection to a supply of the second material and being configured to add the second material to the reservoir, and wherein the controller is configured to operate the apparatus to selectively add the second material responsive to the computer instructions.

10. The computer-controlled apparatus according to claim 9, wherein the controller progressively adds the second material to the reservoir in proportion to the deposition head progressively depositing the first material, thereby further submerging the at least a portion of the object in the second material.

11-16. (canceled)

17. The computer-controlled apparatus according to claim 9, further comprising an inlet arranged to convey the supply of second material to the reservoir, an outlet arranged to convey second material out of the reservoir, and a recirculation system in communication with the outlet and the inlet and configured to convey the second material from the outlet to the inlet.

18. The computer-controlled apparatus according to claim 1, further comprising a connection to a supply of one or more additives configured to affect properties of the first material, the apparatus configured to selectively add the one or more additives to the second material, and wherein the controller is configured to operate the apparatus to selectively add the one or more additives responsive to the computer instructions.

19. The computer-controlled apparatus according to claim 18, wherein the one or more additives are catalysts configured to accelerate curing of the first material.

20. (canceled)

21. The computer-controlled apparatus according to claim 1, further comprising a climate control system for adjusting one or more environmental conditions of the reservoir, and wherein the controller is configured to selectively operate the climate control system responsive to the computer instructions.

22. (canceled)

23. The computer-controlled apparatus according to claim 21, wherein the climate control system is configured to selectively add one or more gases to the reservoir.

24. The computer-controlled apparatus according to claim 39, wherein the one or more vibration generators are configured to be movable within the reservoir, and wherein the controller is adapted to selectively move the vibration generators within the reservoir responsive to the computer instructions, thereby agitating the second material in respective one or more specific locations.

25-26. (canceled)

27. The computer-controlled apparatus according to claim 39, further comprising a plurality of the vibration generators arranged in a linear array extending between a rim of the reservoir and the base.

28-34. (canceled)

35. The computer-controlled apparatus according claim 39, wherein the second material is configured to be substantially liquid.

36. The computer-controlled apparatus according to claim 39, wherein the second material is configured to be one of shear-thickening and shear-thinning and wherein operation of the one or more vibration generators induces shear-thickening or shear-thinning of the second material.

37. The computer-controlled apparatus according to claim 1, wherein the second material is configured to be granular.

38. (canceled)

39. The computer-controlled apparatus according to claim 1, wherein the apparatus further comprises one or more vibration generators arranged to agitate at least a portion of the second material, and the controller is configured to operate the one or more vibration generators to induce flow of the second material around the at least a portion of the object submerged in the second material.

40. The computer-controlled apparatus according to claim 1, wherein the second material is configured to be less dense than the first material.
